(19) United States
(12) Patent Application Publication
(10) Pub. No.: US 2024/0334917 A1
(43) Pub. Date: Oct. 10, 2024

(54) Ice Fishing Hole Net Device

(71) Applicants: Ronald Kittelson, Montevideo, MN (US); Lorie Richardson-Kittelson, Montevideo, MN (US)

(72) Inventors: Ronald Kittelson, Montevideo, MN (US); Lorie Richardson-Kittelson, Montevideo, MN (US)

(21) Appl. No.: 18/623,214

(22) Filed: Apr. 1, 2024

Related U.S. Application Data
(60) Provisional application No. 63/494,069, filed on Apr. 4, 2023.

(51) Int. Cl. A01K 77/00

(52) U.S. Cl. CPC A01K 77/00

(57) ABSTRACT

An ice fishing hole net device is provided comprised of a spring-loaded shaft, a handle, and a net. The shaft enables automatic upward movement to capture a fish efficiently inside an ice fishing hole. The handle is equipped with a fastener that sets the shaft's depth in the ice hole, preventing the device from falling through during use. Another fastener at the net end acts as a lower bound for the spring of the shaft, also setting the shaft's depth. The device includes a shaft plate bracket that can be fastened to the ice fishing house floor, allowing adjustable placement within the ice hole. In its locked position, the device keeps the spring compressed until a fish is reeled close, whereupon the user can unlock it, allowing the spring to extend the shaft and raise the net, effectively trapping the fish.

### CROSS-REFERENCE TO RELATED APPLICATION

The present application claims priority to, and the benefit of, U.S. Provisional Application No. 63/494,069, which was filed on Apr. 4, 2023, and is incorporated herein by reference in its entirety.

### FIELD OF THE INVENTION

The present invention relates generally to the field of fishing nets. More specifically, the present invention relates to an ice fishing hole net device that provides a spring-loaded fishing net that can be deployed to secure a fish within an ice fishing hole once caught. Accordingly, the present disclosure makes specific reference thereto. Nonetheless, it is to be appreciated that aspects of the present invention are also equally applicable to other like applications, devices, and methods of manufacture.

### BACKGROUND

Ice fishing, often pursued during the winter months when frozen bodies of water transform into icy landscapes, requires different techniques than traditional fishing. One popular method employed in ice fishing is the use of tip-ups and other standard fishing methods that allow anglers to suspend their lines beneath the ice surface. One of the primary challenges faced by ice fishermen is the task of reeling in a thrashing fish within the small confines of an ice fishing hole. As the angler exerts force on the fishing line, the fish's resistance intensifies, often resulting in violent movements that make the retrieval process difficult. Amid this struggle, there is a looming risk of losing the fish back into the water.

Compounding this difficulty, when attempting to grab a thrashing fish out of the hole, there is a considerable chance that the fish may wriggle free from the hook, evading capture and finding its way back into the water below. This frustrating turn of events not only tests the angler's patience but also diminishes the gratification derived from the fishing experience

Therefore, there exists a long-felt need in the art for an ice fishing aid. There also exists a long-felt need in the art for an ice fishing aid that helps fishermen catch and retain fish while ice fishing. More specifically, there exists a long-felt need in the art for an ice fishing hole net device that allows a user to secure a fish in an ice fishing hole once caught. Further, there exists a long-felt need in the art for an ice fishing hole net device that allows a user to secure a fish in an ice fishing hole once caught, while also preventing said fish from escaping once removed from a hook.

The subject matter disclosed and claimed herein, in one embodiment thereof, comprises an ice fishing hole net device. The device is comprised of a spring-loaded shaft, a handle, and a net. The shaft enables automatic upward movement to capture a fish efficiently inside an ice fishing hole. The handle is equipped with a fastener that sets the shaft's depth in the ice hole, preventing the device from falling through during use. The net end attaches to the shaft via a frame, secured by a lock washer and nut assembly. Another fastener at the net end acts as a lower bound for the spring of the shaft, also setting the shaft's depth. The device includes a shaft plate bracket that can be fastened to the ice fishing house floor, allowing adjustable placement within the ice hole. In its locked position, the device keeps the spring compressed until a fish is reeled close, whereupon the user can unlock it, allowing the spring to extend the shaft and raise the net, effectively trapping the fish.

In this manner, the ice fishing hole net device of the present invention accomplishes all the forgoing objectives and provides an ice fishing aid that helps fishermen catch and retain fish while ice fishing. More specifically, the device allows a user to secure a fish in an ice fishing hole once caught. Further, the device allows a user to secure a fish in an ice fishing hole once caught, while also preventing said fish from escaping once removed from a hook.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an ice fishing hole net device that provides an ice fishing landing net that can be used to secure a fish in an ice fishing hole. The device is primarily comprised of a shaft with a first end with at least one handle and a second end with at least one net. The shaft is spring-loaded via at least one spring such that it can be automatically raised upwards within an ice fishing hole to secure a fish within an ice fishing hole.

The shaft is comprised of a first end with at least one handle. The first end of the shaft is also comprised of at least one fastener that serves as the upper bound for at least one spring that surrounds the shaft. The fastener also serves to set the depth of the shaft within an ice fishing hole by preventing the shaft from falling completely through a shaft opening in a shaft plate bracket.

The second end of the shaft is comprised of a net. In addition, the second end is comprised of at least one fastener that serves as the lower bound for at least one spring that surrounds the shaft. The fastener also serves to set the depth of the shaft within an ice fishing hole by preventing the shaft from being pulled completely upwards through a shaft opening in a shaft plate bracket.

To attach to/around an ice fishing hole, the device is comprised of at least one shaft plate bracket that can be secured to the floor of an ice fishing house (or ice surface) via at least one fastener that penetrates the floor in the fish house into the ice hole sleeve via at least one fastener opening in the bracket. The fastener is repositionable in a fastener opening. The fastener opening is preferably a channel that runs at least half of the length of the bracket. This allows the bracket (and thus, shaft) to extend further out into the center of an ice fishing hole or closer to the hole edge.

When a fish has not been hooked on a fishing line and has not been reeled to the ice hole, the device remains in a “locked” position. In said position, the spring is in compression between the shaft plate bracket and fastener. The spring remains in this position until a fish has been reeled near the hole. Once a fish has been reeled inside the hole, a user can rotate the handle to disengage the spring. This places the spring into a state of tension and places the device in an “unlocked” position. As a result of the tensioned state of the spring, the spring propels the shaft upward within the housing and through the opening of the shaft plate bracket until the fastener contacts the bottom of the housing, stopping the upward travel of the shaft. This process effectively raises the net within the hole to secure the fish as the net covers the bottom of the hole to prevent the fish from escaping (even after being unhooked).

Accordingly, the ice fishing hole net device of the present invention is particularly advantageous as it provides an ice fishing aid that helps fishermen catch and retain fish while ice fishing. More specifically, the device allows a user to secure a fish in an ice fishing hole once caught. Further, the device allows a user to secure a fish in an ice fishing hole once caught, while also preventing said fish from escaping once removed from a hook. In this manner, the ice fishing hole net device provides a useful ice fishing device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an ice fishing hole net device of the present invention in an unlocked state in accordance with the disclosed architecture;

FIG. 2 illustrates a perspective view of one potential embodiment of an ice fishing hole net device of the present invention in a locked state in accordance with the disclosed architecture;

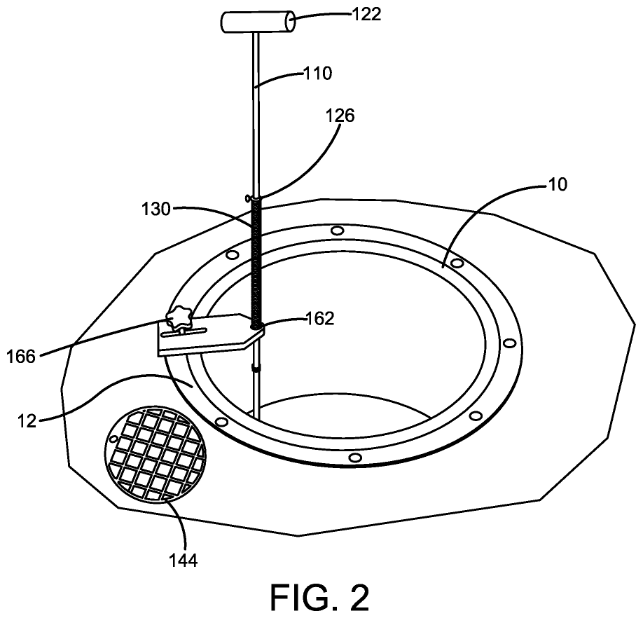

FIG. 3 illustrates a perspective view of one potential embodiment of an ice fishing hole net device of the present invention in a locked state in accordance with the disclosed architecture;

FIG. 4 illustrates a perspective view of one potential embodiment of an ice fishing hole net device of the present invention in an unlocked state in accordance with the disclosed architecture;

FIG. 5 illustrates a perspective view of one potential embodiment of an ice fishing hole net device of the present invention in an unlocked state in accordance with the disclosed architecture;

FIG. 6 illustrates a perspective view of one potential embodiment of an ice fishing hole net device of the present invention in accordance with the disclosed architecture; and

FIG. 7 illustrates a flowchart of a method of using one potential embodiment of an ice fishing hole net device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an ice fishing aid. There also exists a long-felt need in the art for an ice fishing aid that helps fishermen catch and retain fish while ice fishing. More specifically, there exists a long-felt need in the art for an ice fishing hole net device that allows a user to secure a fish in an ice fishing hole once caught. Further, there exists a long-felt need in the art for an ice fishing hole net device that allows a user to secure a fish in an ice fishing hole once caught, while also preventing said fish from escaping once removed from a hook.

The present invention, in one exemplary embodiment, is comprised of an ice fishing hole net device. The device provides an ice fishing landing net that can be used to secure a fish in an ice fishing hole. The device is primarily comprised of a shaft with a first end with at least one handle and a second end with at least one net, wherein the shaft is spring-loaded via at least one spring. In this manner, the shaft can be automatically raised upwards within an ice fishing hole to secure a fish within an ice fishing hole.

The shaft is comprised of a first end with at least one handle and at least one fastener that serves as the upper bound for at least one spring that surrounds the shaft. The fastener also serves to set the depth of the shaft within an ice fishing hole by preventing the shaft from falling completely through a shaft opening in a shaft plate bracket.

The second end of the shaft is comprised of a net. In addition, the second end is comprised of at least one fastener that serves as the lower bound for at least one spring that surrounds the shaft. The fastener further serves to set the depth of the shaft within an ice fishing hole by preventing the shaft from being pulled completely upwards through a shaft opening in a shaft plate bracket.

To attach to/around an ice fishing hole, the device is comprised of at least one shaft plate bracket. The bracket can be secured to the floor of an ice fishing house (or ice surface) via at least one fastener that penetrates the floor in the fish house into the ice hole sleeve via at least one fastener opening in the bracket. The fastener is repositionable in a fastener opening. The fastener opening is preferably a channel that runs at least half of the length of the bracket. This allows the bracket (and thus, shaft) to extend further out into the center of an ice fishing hole or closer to the hole edge.

When a fish has not been hooked on a fishing line and has not been reeled to the ice hole, the device remains in a “locked” position. In said position, the spring is in compression between the shaft plate bracket and fastener. The spring remains in this position until a fish has been reeled near the hole. Once a fish has been reeled inside the hole, a user can rotate the handle to disengage the spring. This places the spring into a state of tension and places the device in an “unlocked” position. As a result of the tensioned state of the spring, the spring propels the shaft upward within the housing and through the opening of the shaft plate bracket until the fastener contacts the bottom of the housing, stopping the upward travel of the shaft. This process effectively raises the net within the hole to secure the fish as the net covers the bottom of the hole to prevent the fish from escaping (even after being unhooked).

Accordingly, the ice fishing hole net device of the present invention is particularly advantageous as it provides an ice fishing aid that helps fishermen catch and retain fish while ice fishing. More specifically, the device allows a user to secure a fish in an ice fishing hole once caught. Further, the device allows a user to secure a fish in an ice fishing hole once caught, while also preventing said fish from escaping once removed from a hook. In this manner, the ice fishing hole net device provides a useful ice fishing device.

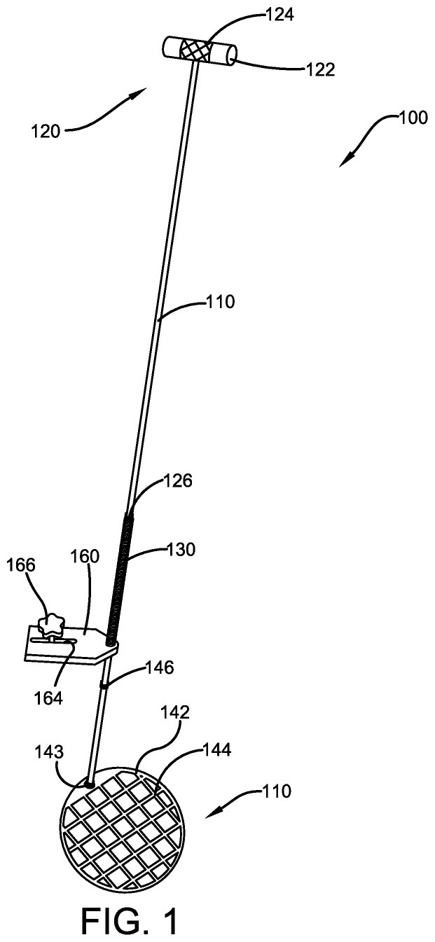

Referring initially to the drawings, FIG. 1 illustrates a perspective view of one potential embodiment of an ice fishing hole net device 100 of the present invention in an unlocked state in accordance with the disclosed architecture. The device 100 provides an ice fishing landing net that can be used to secure a fish in an ice fishing hole 10. The device 100 is primarily comprised of a shaft 110 with a first end 120 with at least one handle 122 and a second end 140 with at least one net 144. The shaft 110 is spring-loaded via at least one spring 130 such that it can be automatically raised upwards within an ice fishing hole 10 to secure a fish within an ice fishing hole 10.

The shaft 110 is comprised of a first end 120 with at least one handle 122. The handle 122 is preferably (but not limited to) a T-shaped handle 122. The handle 122 may be comprised of at least one grip area 124 that improves grip on the handle 122. The grip area 124 may be comprised of a non-slip material such as but not limited to rubber, and also of a raised or recessed texture.

The first end 120 of the shaft 110 is also comprised of at least one fastener 126. The fastener 126 is preferably (but not limited to) a clamp-style fastener with a threaded set screw that can be repositioned along the shaft 110. The fastener 126 serves as the upper bound for at least one spring 130 that surrounds the shaft 110. The fastener 126 also serves to set the depth of the shaft 110 within an ice fishing hole 10 by preventing the shaft 110 from falling completely through a shaft opening 162 in a shaft plate bracket 160.

The second end 140 of the shaft 110 is comprised of a net 144. The net 144 is preferably round and of any diameter, but may be any shape in different embodiments. At least one frame 142 of the net 144 attaches to the shaft 110. The net 144 may be any spacing and net type known in the art. The net 144 is secured by a lock washer and nut assembly 143 on both the top and bottom of the net 144 to attach the net frame 142 to the shaft 110 at the second end 140.

In addition, the second end 140 is comprised of at least one fastener 146. The fastener 146 is preferably (but not limited to) a clamp-style fastener with a threaded set screw that can be repositioned along the shaft 110. The fastener 146 serves as the lower bound for at least one spring 130 that surrounds the shaft 110. The fastener 146 also serves to set the depth of the shaft 110 within an ice fishing hole 10 by preventing the shaft 110 from being pulled completely upwards through a shaft opening 162 in a shaft plate bracket 160.

To attach to/around an ice fishing hole 10, the device 100 is comprised of at least one shaft plate bracket 160. The shaft plate bracket 160 can be secured to a floor of an ice fishing house (or ice surface) via at least one fastener 154 such as but not limited to a bolt, a screw, etc. The fastener 154 penetrates the floor in the fish house into the ice hole sleeve 12 via at least one fastener opening 164 in the bracket 160. The fastener 166 is repositionable in a fastener opening 164. The fastener opening 164 is preferably a channel that runs preferably at least half of the length of the bracket 160. This allows the bracket 160 (and thus, shaft 110) to extend further out into the center of an ice fishing hole 10 or closer to the hole 10 edge.

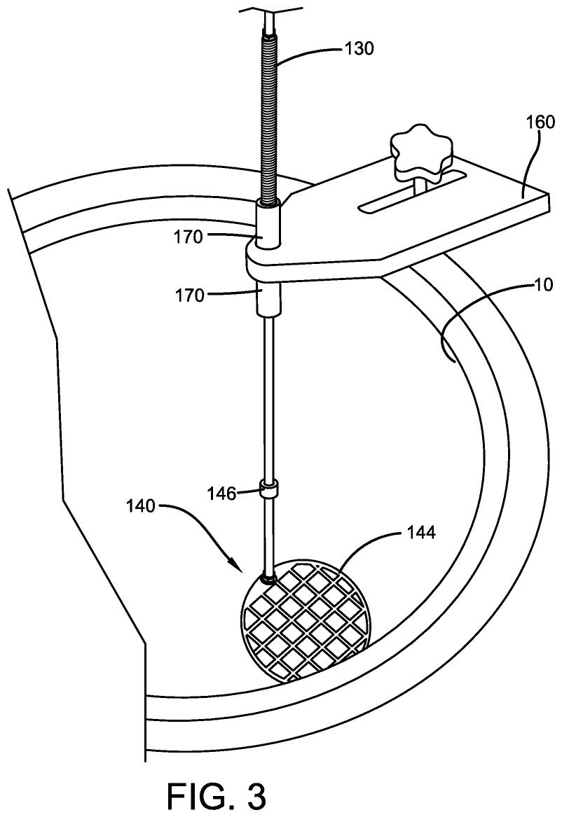

When a fish has not been hooked on a fishing line and has not been reeled to the ice hole 10, the device 100 remains in a “locked” position. The locked position can be observed from a view looking into the hole from a first perspective in FIG. 1, which focuses on the first end 120 of the shaft 110, and from a second perspective in FIG. 3, which focuses on the second end 140 of the shaft 110. In said position, the spring 130 is in compression between the shaft plate bracket 160 and fastener 126. The spring 130 may be secured in this position via at least one shaft plate bracket 160. To secure the spring 130 into said position, a user rotates the handle 122 to rotate the shaft 110 180 degrees in a first direction within the housing 170 such that the frame 142 and net 144 are positioned in the water such that they are not positioned within the ice fishing hole 10, as best seen in FIG. 3. The spring 130 then remains in this position until as fish has been reeled near the hole 10.

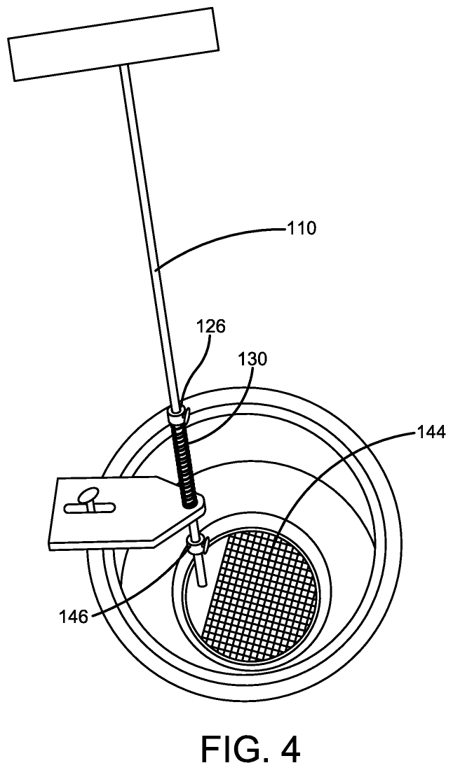

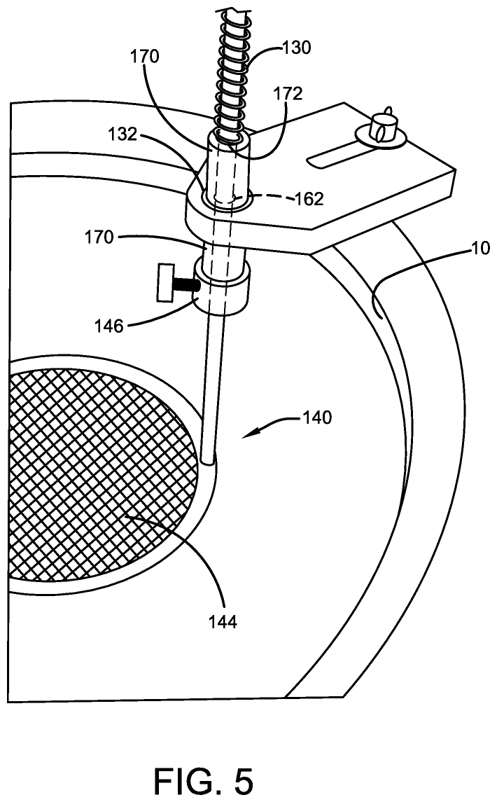

Once a fish has been reeled inside the hole 10, a user can rotate the handle 122 in a second direction (opposite of the first direction) to rotate the shaft 110 180-degrees and disengage the spring 130. This places the spring 130 into a state of tension and places the device 100 in an “unlocked” position which can be observed from a view looking into the hole from a first perspective in FIG. 4, which focuses on the first end 120 of the shaft 110, and from a second perspective in FIG. 5, which focuses on the second end 140 of the shaft 110.

As a result of the tensioned state of the spring 130, the spring 130 propels the shaft 110 upward within the housing 170 and through the opening 162 of the shaft plate bracket 160 until the fastener 146 contacts the bottom of the housing 170, stopping the upward travel of the shaft 110. This process effectively raises the net 144 within the hole 10 to secure the fish, as during the rotation process of the handle 122 the net 144 was rotated 180 degrees such that the net 144 now covers the bottom of the hole 10 to prevent the fish from escaping (even after being unhooked), as best seen in FIG. 4.

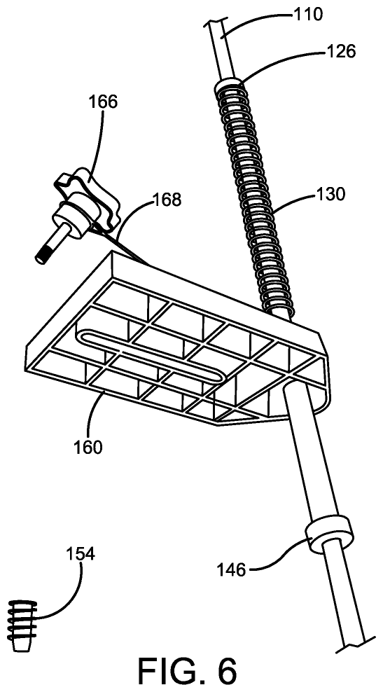

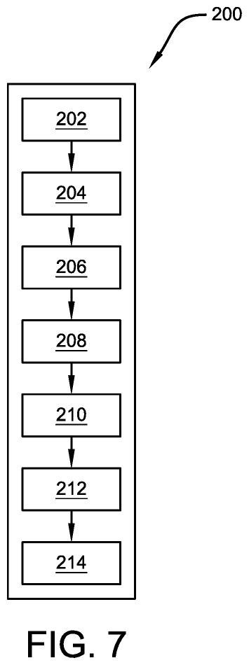

The present invention is also comprised of a method of using 200 the device 100, as seen in FIG. 7. First, a device 100 is provided comprised of a shaft 110 with at least one handle 122, at least one spring 130, and at least one net 144; and at least one shaft plate bracket 160 comprised of at least one shaft opening 162 and at least one fastener opening 164 [Step 202]. Then, the shaft plate bracket 160 is secured to a surface outside an ice fishing hole 10 via at least one fastener 154 that is inserted in the ice hole sleeve ring 12 that is mounted in the floor around the ice fishing hole 10. The fastener knob 166 can then be placed through the opening 164 of the shaft plate bracket 160 and into said surface [Step 204]. The fastener knob 166 can then be secured in place with at least one wire 168 attached to the fastener knob 166 and to the main shaft 110, as seen in FIG. 6 [Step 206]. Then, the shaft 110 can be inserted through the shaft opening 162 in the shaft plate bracket 160 and placed into the ice fishing hole 10 [Step 208]. Next, the handle 122 can be rotated 180 degrees in a first direction to rotate the shaft 110 (and thus the net 144) away from the bottom of the hole 10 while still remaining under the ice and can be locked in said position by pushing down the handle 122 and causing the spring 130 to engage the spring catch 132 while in compression [Step 210]. Once a fish has been hooked, the fish can be reeled into the hole 10 above the height of the net 144 [Step 212]. Then, the handle 122 can be pressed down and turned 180 degrees in a second direction (the opposite of the first direction) such that the spring 130 becomes unengaged from the catch 132 [Step 214]. This causes the spring 130 to be placed in a state of tension, which causes the shaft 110 (and thus, the net 144) to move upwards through the shaft opening 162 of the bracket 160 which also allows the net 144 to be raised upwards and cover the bottom of the ice fishing hole to prevent a fish within the hole 10 from escaping.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ice fishing hole net device” and “device” are interchangeable and refer to the ice fishing hole net device 100 of the present invention.

Notwithstanding the forgoing, the ice fishing hole net device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ice fishing hole net device 100 as shown in the FIGS. are for illustrative purposes only, and that many other sizes and shapes of the ice fishing hole net device 100 are well within the scope of the present disclosure. Although the dimensions of the ice fishing hole net device 100 are important design parameters for user convenience, the ice fishing hole net device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ice fishing hole net device comprising:
a shaft comprised of:
a first end comprised of:
a handle;
a spring;
a first fastener;
a second end comprised of:
a net;
a frame;
a second fastener; and
a shaft plate bracket.

2. The ice fishing hole net device of claim 1, wherein the handle is comprised of a T-shaped handle.

3. The ice fishing hole net device of claim 1, wherein the handle is comprised of a grip area.

4. The ice fishing hole net device of claim 1, wherein the first fastener and the second fastener are repositionable along the shaft.

5. The ice fishing hole net device of claim 1, wherein the net is comprised of a frame.

6. The ice fishing hole net device of claim 5, wherein the frame attaches to the shaft.

7. The ice fishing hole net device of claim 1, wherein the spring is positioned between the first fastener and the second fastener.

8. An ice fishing hole net device comprising:
a shaft comprised of:
a first end comprised of:
a handle;
a spring;
a first fastener;
a second end comprised of:
a net;
a frame;
a second fastener; and
a shaft plate bracket comprised of a first opening, a second opening, and a third fastener.

9. The ice fishing hole net device of claim 8, wherein the third fastener is comprised of a bolt or a screw.

10. The ice fishing hole net device of claim 8, wherein the first opening receives the shaft.

11. The ice fishing hole net device of claim 8, wherein the handle is comprised of a T-shaped handle.

12. The ice fishing hole net device of claim 8, wherein the handle is comprised of a grip area.

13. The ice fishing hole net device of claim 8, wherein the first fastener and the second fastener are repositionable along the shaft.

14. The ice fishing hole net device of claim 8, wherein the net is comprised of a frame.

15. The ice fishing hole net device of claim 14, wherein the frame removably attaches to the shaft.

16. The ice fishing hole net device of claim 8, wherein the spring is positioned between the first fastener and the second fastener.

17. The ice fishing hole net device of claim 8 further comprised of a fourth fastener.

18. The ice fishing hole net device of claim 17, wherein the fourth fastener is comprised of a screw or a bolt.

19. A method of using an ice fishing hole net device, the method comprising the following steps:
providing an ice fishing hole net device comprised of a shaft comprised of a handle, a spring, a net, and a shaft plate bracket comprised of a shaft opening and a fastener opening;
securing the shaft plate bracket to an ice hole sleeve ring that surrounds an ice fishing hole;
inserting the shaft through the shaft opening and into the ice fishing hole;
rotating the handle 180 degrees in a first direction and pushing down the handle to lock the shaft in position;
reeling a fish into the ice fishing hole above the net; and
pressing the handle down and rotating the handle 180 degrees in a second direction opposite of the first direction.

20. The method of using an ice fishing hole net device of claim 19, wherein the net is removably attached to the shaft.
